(19) United States
(12) Patent Application Publication
(10) Pub. No.: US 2018/0229890 A1
(43) Pub. Date: Aug. 16, 2018

(54) COLLAPSIBLE GARBAGE CONTAINER

(71) Applicant: Justice Fletcher, Mulino, OR (US)

(72) Inventor: Justice Fletcher, Mulino, OR (US)

(21) Appl. No.: 15/891,540

(22) Filed: Feb. 8, 2018

Related U.S. Application Data
(60) Provisional application No. 62/459,599, filed on Feb. 15, 2017.

(51) Int. Cl. B65D 21/08; B65F 1/14

(52) U.S. Cl. CPC B65D 21/086; B65F 1/14; B65F 2220/124; B65F 2220/108; B65F 2220/106

(57) ABSTRACT

A trash receptacle with a collapsible construction configured to allow a user to collapse the receptacle and remove each of the pieces to be manually cleaned or washed in a dishwasher. The collapsible garbage container may allow a user to clean their garbage container in the dishwasher by providing a plurality of pieces that are easy to disassemble for purposes of maintaining a clean and sanitary garbage container and to minimize bad odor and insects which may be attracted to the smell of garbage.

### CROSS-REFERENCE TO RELATED APPLICATION(S)

The present application is related to and claims priority to U.S. Provisional Patent Application No. 62/459,599 filed Feb. 15, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of containers of existing art and more specifically relates to a container for garbage that is collapsible.

### RELATED ART

Garbage containers tend to get dirty, stained, and unsanitary over time. Once a container starts getting moldy or odorous, it may be instantly replaced. If a spill or accident occurs, a brand-new garbage container can become completely unusable, forcing an individual into purchasing a new one. Constantly purchasing new garbage containers can get expensive and frustrating.

U.S. Pat. No. 5,862,932 to Carolyn Walsh relates to a portable collapsible garbage can. The described portable collapsible garbage can may include a central vertical axis and inner and outer sides and concentrically adjacently spaced substantially vertically oriented annular flat wall panels. Each wall panel has upper and lower distal ends and there is an innermost and outermost wall panel. The wall panels are concentrically oriented about the vertical axis and can be vertically telescopically raised and lowered between an extended and a retracted position. In the extended position the panels partially overlap along the vertical axis and define a garbage compartment having an open top and bottom. In the retracted position the panels are concentrically nested adjacent each other and overlapped along the vertical axis.

### SUMMARY OF THE INVENTION

In view of the foregoing disadvantages inherent in the known containers art, the present disclosure provides a novel collapsible garbage container. The general purpose of the present disclosure, which will be described subsequently in greater detail, is to provide a garbage container assembly that is collapsible into several parts which may be manually cleaned or loaded into a conventional dishwasher for cleaning purposes.

The present disclosure teaches a trash receptacle with a collapsible construction configured to allow a user to collapse the receptacle and remove each of the pieces to be manually cleaned or washed in a dishwasher. The easy wash garbage container may allow a user to clean their garbage container in the dishwasher by providing a plurality of pieces that are easy to disassemble for purposes of maintaining a clean and sanitary garbage container and to minimize bad odor and insects which may be attracted to the smell of garbage.

In one embodiment, a collapsible garbage container has a top, a bottom, a deployed configuration, and a decoupled configuration. The collapsible garbage container may essentially comprise a garbage opening, a base, a collapsible sidewall and a lid.

The garbage opening may be configured to receive pieces of garbage and trash. Further, the garbage opening may comprise a garbage bag retainer configured to retain a garbage bag in an open-condition for collecting garbage, trash, and other waste.

The base may be configured to support the collapsible garbage container on a flat surface and may be further configured to prevent the garbage from exiting the bottom of the collapsible garbage container when the collapsible garbage container is in the deployed configuration.

The collapsible sidewall may circumscribe the garbage opening and may extend between the garbage opening and the base. The collapsible sidewall may be configured to retain the garbage from laterally exiting the collapsible garbage container when the collapsible garbage container is in the deployed configuration. The collapsible sidewall may be removably coupled to the base and may also include a plurality of sidewall segments removably coupled together.

The lid may be removably coupled to the collapsible sidewall and the lid may have an open state and a closed state. The lid may be configured to permit the garbage to enter the garbage opening while in the open state and may be further configured to prevent the garbage from entering the garbage opening while in the closed state.

As may be appreciated, when the collapsible garbage container is in the decoupled configuration, the garbage opening, the base, the collapsible sidewall and the lid may be cleaned easily by hand or may be placed in a dishwasher or comparable washing machine for cleaning. Further, when in the decoupled configuration, the collapsible garbage container may be compactly packed together for space conservation and ease of transport.

A method of using the collapsible garbage container may comprise the steps of: providing the collapsible garbage container; disposing of at least one piece of garbage inside a garbage bag retained by a garbage bag retainer of a garbage opening of the collapsible garbage container; removing the garbage bag when full; collapsing the collapsible garbage container into a decoupled configuration, the decoupled configuration comprising a plurality of parts including the garbage opening, a base, a collapsible sidewall including a plurality of sidewall segments, and a lid; cleaning the plurality of parts via a dishwasher and alternatively washing the plurality of parts by hand; assembling the plurality of parts into a deployed configuration; and deploying the collapsible garbage container for continuous sanitary use thereof.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dishwasher-friendly collapsible garbage container, constructed and operative according to the teachings of the present disclosure.

FIG. 1A is a view of a collapsible garbage container in a deployed condition showing a user disposing trash into a garbage opening of the collapsible garbage container, according to an embodiment of the disclosure.

FIG. 1B is a view of the collapsible garbage container in a decoupled condition showing the collapsible garbage container disassembled and suitable for cleaning in a dishwasher, according to an embodiment of the disclosure.

FIG. 2 is an exploded view of the collapsible garbage container comprising a garbage opening, a base, a collapsible sidewall and a lid according to an embodiment of the present disclosure.

FIG. 3A is a top perspective view of the base of the collapsible garbage container comprising a basin useful for retaining a volume of spilled liquid, according to an embodiment of the present disclosure.

FIG. 3B is a bottom perspective view of the base of the collapsible garbage container comprising a grip useful for adding traction, according to an embodiment of the present disclosure.

FIG. 4 is a perspective view of the collapsible garbage container further comprising a hands-free lid opener assembly, according to an embodiment of the present disclosure.

FIG. 5 is a flow diagram illustrating a method of use for the collapsible garbage container configured to be cleaned, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to containers and more particularly to a collapsible garbage container as used to improve the maintained cleanliness of garbage containers.

Generally, an embodiment of the collapsible garbage container of the present disclosure may comprise a multi-piece garbage container structured and arranged to be easily disassembled for cleaning purposes. In one embodiment, the collapsible garbage container may be broken down into seven separate pieces and placed within a dishwasher for cleaning thereof. Each piece may be coupled together via male/female connectors, snaps, or fasteners. The collapsible garbage container is designed to minimize germs and bacteria when storing trash for an extended over a period of use of the garbage container. By washing the collapsible garbage container with regularity, odors and stains are kept to a minimum.

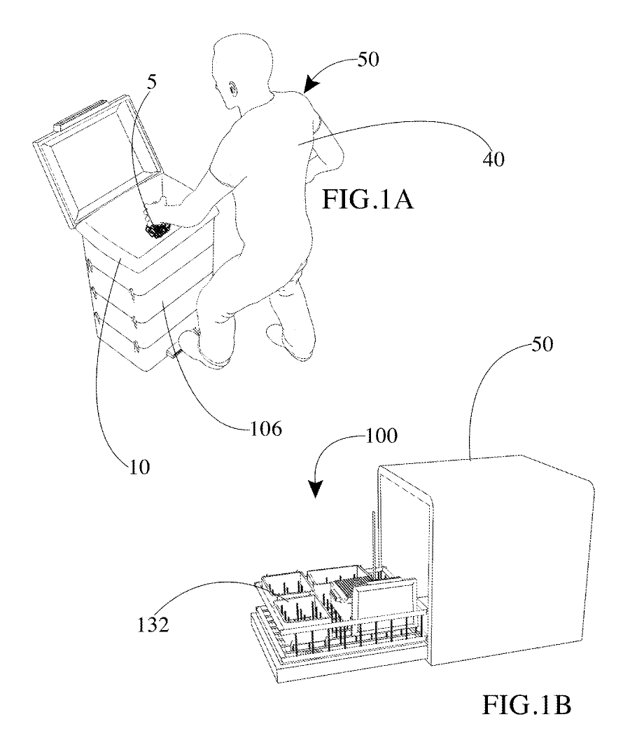

Referring now more specifically to the drawings by numerals of reference, there is shown in FIGS. 1A-4, various views of the collapsible garbage container 100. As shown, the collapsible garbage container 100 has a top 102, a bottom 104, a deployed configuration 106, and a decoupled configuration 108. The collapsible garbage container 100 may be structurally defined by a garbage opening 110, a base 120, a collapsible sidewall 130, and a lid 140.

FIG. 1A shows a view of the collapsible garbage container 100 in a deployed condition 106 depicting a user 40 disposing trash according to an embodiment of the present disclosure. Here, the collapsible garbage container 100 may be beneficial for use by a user 40 to throw away trash, garbage 5, and other waste. As illustrated, the collapsible garbage container 100 may include the garbage opening 110, the base 120, the collapsible sidewall 130, and the lid 140.

FIG. 1B shows a view of the collapsible garbage container 100 in a decoupled condition 108 showing the collapsible garbage container 100 disassembled and suitable for cleaning the collapsible garbage container 100 in a dishwasher 20, according to an embodiment of the disclosure.

According to one embodiment, the collapsible garbage container 100 may be arranged as a kit 105. In particular, the collapsible garbage container 100 may further include a set of instructions 107. The instructions 107 may detail functional relationships in relation to the structure of the collapsible garbage container 100 such that the collapsible garbage container 100 can be used, maintained, or the like, in a preferred manner.

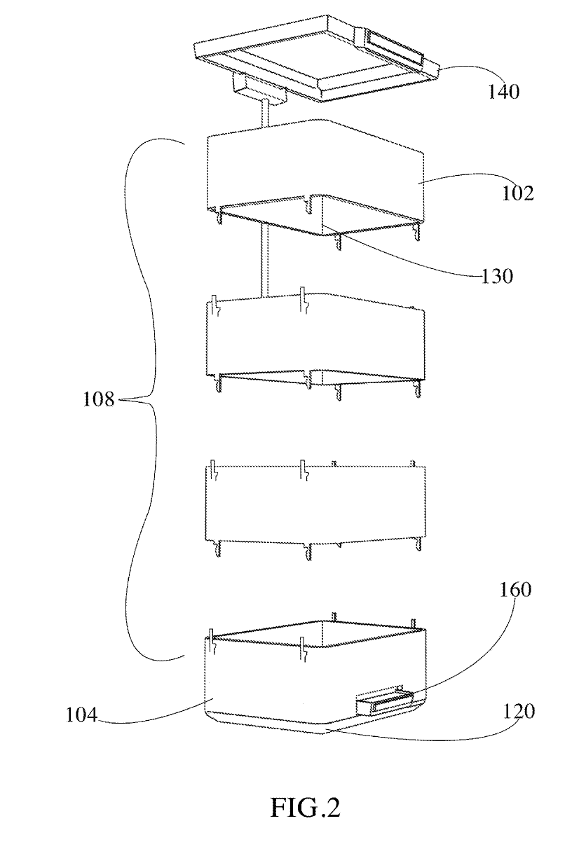

FIG. 2 is an exploded view of the collapsible garbage container 100 comprising a garbage opening 110, a base 120, a collapsible sidewall 130 and a lid 140 according to an embodiment of the present disclosure. As shown, the garbage opening 110 may be configured to receive garbage 5, trash, and other waste. The base 120 may be configured to support the collapsible garbage container 100 on a flat surface and may further be configured to prevent the garbage 5 from exiting the bottom 104 of the collapsible garbage container 100 when the collapsible garbage container 100 is in the deployed configuration 106.

The collapsible sidewall 130 may circumscribe the garbage opening 110 and extend between the garbage opening 110 and the base 120. The collapsible sidewall 130 may be configured to retain the garbage 5 from laterally exiting the collapsible garbage container 100 when the collapsible garbage container 100 is in the deployed configuration 106. The collapsible sidewall 130 may be removably coupled to the base 120 and may include a plurality of sidewall segments 132 removably coupled together.

The lid 140 may be removably coupled to the collapsible sidewall 130 and may have an open state 142 and a closed state 144. Further, the lid 140 may be configured to permit garbage 5 to enter the garbage opening 110 while in the open state 142 and may further be configured to prevent the garbage 5 from entering the garbage opening 110 while in the closed state 144.

As seen best in FIG. 1A and FIG. 2, the garbage opening 110 may be integrated with the collapsible sidewall 130. Further, the garbage opening 110 may include a garbage bag retainer 112. The garbage bag retainer 112 may be useful for holding and retaining a garbage bag 10 in place within the collapsible garbage container 100.

In continuing to refer to FIG. 2, each of the plurality of sidewall segments 132 may include at least one male insert 134 and at least one female receiver 136 on opposing ends that are configured such that the sidewall segments are coupleable together. Further, each of the plurality of plurality of sidewall segments 132 may include at least one male insert 134 and at least one female receiver 136 on opposing ends that are configured such that the plurality of mid-sectional pieces is decoupleable. In such a manner, the plurality of sidewall segments 132 and the plurality of mid-sectional pieces may be washed individually by hand or may be collectively placed into a dishwashing machine for cleaning purposes.

In one embodiment of the collapsible sidewall 130, the plurality of sidewall segments 132 consists of two sidewall segments. In another embodiment of the collapsible sidewall 130, the plurality of sidewall segments 132 consists of three sidewall segments. In yet another embodiment of the collapsible sidewall 130, the plurality of sidewall segments 132 consists of four sidewall segments. In yet another embodiment of the collapsible sidewall 130, the plurality of sidewall segments 132 consists of five sidewall segments. In yet another embodiment of the collapsible sidewall 130, the plurality of sidewall segments 132 consists of six sidewall segments. It should be appreciated that even more than six sidewall segments may be utilized.

In one embodiment of the present invention, the collapsible garbage container 100 may further comprise at least one handle 138 affixed to the collapsible sidewall 130. The handle 138 may be useful for carrying or moving the collapsible garbage container 100 when in a deployed configuration 106.

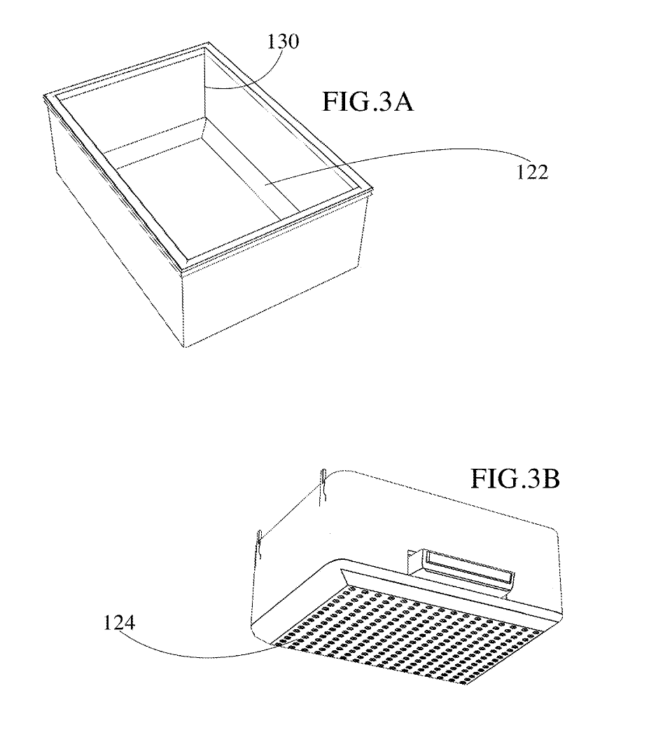

Referring now to FIG. 3A and 3B showing a top perspective view and a bottom perspective view of the base 120 respectively. As shown in FIG. 3A, the base 120 may comprise a basin 122. In one embodiment, the basin 122 may be configured to retain at least 3 liters of a liquid. In such a manner, the basin 122 is able to hold any loose liquid that spills from the garbage bag 10 within the collapsible garbage container 100 to prevent leaks from occurring at the base 120.

As shown in FIG. 3B, the base 120 may include at least one grip surface 124 configured to inhibit sliding movement of the base 120 on the flat surface. The grip surface 124 may be advantageous to provide traction to the collapsible garbage container 100 when in the deployed configuration 106.

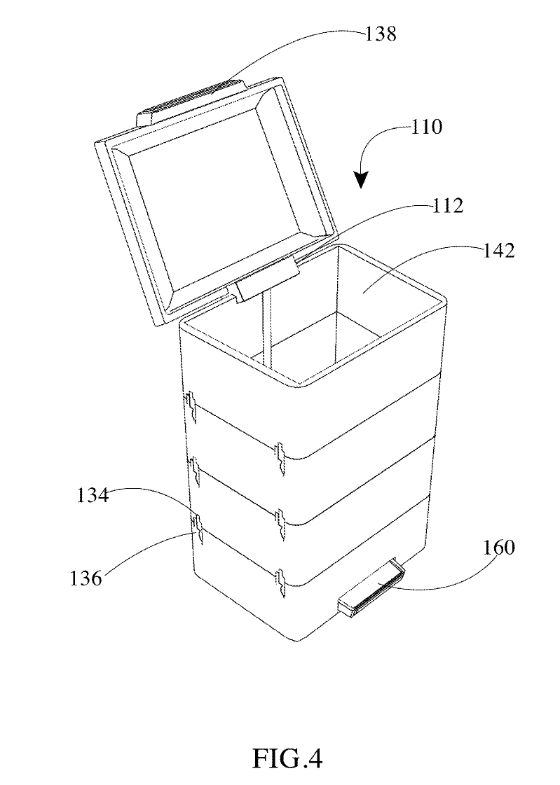

FIG. 4 is a perspective view of the collapsible garbage container 100 further comprising a hands-free lid opener assembly 160, according to an embodiment of the present disclosure. As shown, the collapsible garbage container 100 may comprise a hands-free lid opener assembly 160 operably coupled to the lid 140 and configured to selectably place the lid 140 in the open state 142 and the closed state 144. Preferably, the hands-free lid opener assembly 160 includes a foot pedal and an activator, the activator joining the lid 140 to the foot pedal such that when the foot pedal is pressed, the activator acts to lift the lid 140.

A preferred embodiment of the collapsible garbage container 100 configured to be cleaned may comprise the collapsible garbage container 100 having a top 102, a bottom 104, a deployed configuration 106, and a decoupled configuration 108. The collapsible garbage container 100 may comprise a garbage opening 110 configured to receive a garbage 5, the garbage opening 110 also including a garbage bag retainer 112 configured to retain a garbage bag 10 that is open for receiving garbage 5. The collapsible garbage container 100 may comprise a base 120 configured to support the collapsible garbage container 100 on a flat surface, and further configured to prevent the garbage 5 from exiting the bottom 104 of the collapsible garbage container 100 when the collapsible garbage container 100 is in the deployed configuration 106, and such that the base 120 also includes a basin 122 configured to retain at least 3 liters of a liquid. The collapsible garbage container 100 may comprise a collapsible sidewall 130 circumscribing the garbage opening 110 and extending between the garbage opening 110 and the base 120, the collapsible sidewall 130 configured to retain the garbage 5 from laterally exiting the collapsible garbage container 100 when the collapsible garbage container 100 is in the deployed configuration 106, the collapsible sidewall 130 removably coupled to the base 120, the collapsible sidewall 130 including a plurality of sidewall segments 132 removably coupled together. The collapsible garbage container 100 may comprise a lid 140 removably coupled to the collapsible sidewall 130, the lid 140 having an open state 142 and a closed state 144, the lid 140 configured to permit the garbage 5 to enter the garbage opening 110 while in the open state 142, and further configured to prevent the garbage 5 from entering the garbage opening 110 while in the closed state 144.

In continuing to refer to the preferred embodiment, each of the plurality of sidewall segments 132 may include at least one male insert 134 and at least one female receiver 136 on opposing ends that are configured such that the plurality of sidewall segments 132 are coupleable together. Further, each of the plurality of plurality of sidewall segments 132 may include at least one male insert 134 and at least one female receiver 136 on opposing ends that are configured such that the plurality of mid-sectional pieces is decoupleable. As may be appreciated, the collapsible garbage container 100, when in the decoupled configuration 108, is structured and arranged to be automatically cleaned by a dishwasher 20 and alternatively manually cleaned by hand.

In continuing to refer to the preferred embodiment, the collapsible garbage container 100 may comprise at least one handle 138 affixed to the collapsible sidewall 130. In addition, the collapsible garbage container 100 may comprise a hands-free lid opener assembly 160 operably coupled to the lid 140 and configured to selectably place the lid 140 in the open state 142 and the closed state 144.

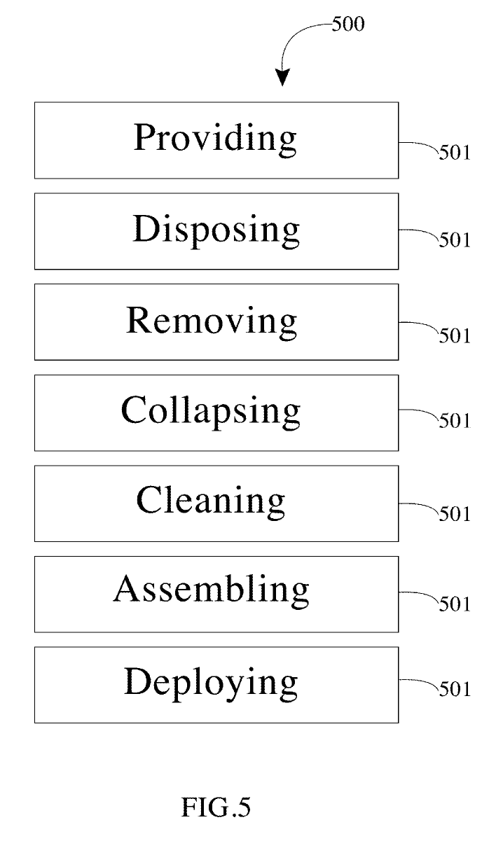

FIG. 5 is a flow diagram 550 illustrating a method of using a collapsible garbage container 100 configured to be cleaned, according to an embodiment of the present disclosure. In particular, the method of using a collapsible garbage container 100 configured to be cleaned 500 may include one or more components or features of the collapsible garbage container 100 as described above. As illustrated, the method of using a collapsible garbage container 100 configured to be cleaned 500 may include the steps of: step one 501, providing the collapsible garbage container 100; step two 502, disposing of at least one piece of garbage 5 inside a garbage bag 10 retained by a garbage bag retainer 112 of a garbage opening 110 of the collapsible garbage container 100; step three 503, removing the garbage bag 10 when full; step four 504, collapsing the collapsible garbage container 100 into a decoupled configuration 108, the decoupled configuration 108 comprising a plurality of parts including the garbage opening 110, a base 120, a collapsible sidewall 130 including a plurality of sidewall segments 132, and a lid 140; step five 505, cleaning the plurality of parts via a dishwasher 20 and alternatively washing the plurality of parts by hand; step six 506, assembling the plurality of parts into a deployed configuration 106; and step seven 507, deploying the collapsible garbage container 100 for continuous sanitary use thereof.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for collapsible garbage container 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A collapsible garbage container having a top, a bottom, a deployed configuration, and a decoupled configuration, the collapsible garbage container comprising:
a garbage opening configured to receive a garbage,
a base configured to support the collapsible garbage container on a flat surface, and further configured to prevent the garbage from exiting the bottom of the collapsible garbage container when the collapsible garbage container is in the deployed configuration;
a collapsible sidewall circumscribing the garbage opening and extending between the garbage opening and the base, the collapsible sidewall configured to retain the garbage from laterally exiting the collapsible garbage container when the collapsible garbage container is in the deployed configuration, the collapsible sidewall removably coupled to the base, the collapsible sidewall including a plurality of sidewall segments removably coupled together; and
a lid removably coupled to the collapsible sidewall, said lid having an open state and a closed state, the lid configured to permit the garbage to enter the garbage opening while in the open state, and further configured to prevent the garbage from entering the garbage opening while in the closed state.

2. The collapsible container of claim 1, wherein the collapsible garbage container is arranged to fit in a volume of approximately 13 gallons when in the deployed configuration.

3. The collapsible container of claim 2, wherein the garbage opening is integrated with the collapsible sidewall.

4. The collapsible container of claim 3, wherein the garbage opening includes a garbage bag retainer.

5. The collapsible container of claim 1, wherein the base includes a basin configured to retain at least 3 liters of a liquid.

6. The collapsible container of claim 1, wherein each of the plurality of sidewall segments includes at least one male insert and at least one female receiver on opposing ends that are configured such that the sidewall segments are coupleable together.

7. The collapsible container of claim 1, wherein each of the plurality of plurality of sidewall segments includes at least one male insert and at least one female receiver on opposing ends that are configured such that the plurality of mid-sectional pieces is decoupleable.

8. The collapsible container of claim 1, wherein the plurality of sidewall segments consists of two sidewall segments.

9. The collapsible container of claim 1, wherein the plurality of sidewall segments consists of three sidewall segments.

10. The collapsible container of claim 1, wherein the plurality of sidewall segments consists of four sidewall segments.

11. The collapsible container of claim 1, wherein the plurality of sidewall segments consists of five sidewall segments.

12. The collapsible container of claim 1, wherein the plurality of sidewall segments consists of six sidewall segments.

13. The collapsible garbage container of claim 1, further comprising at least one handle affixed to the collapsible sidewall.

14. The collapsible garbage container of claim 1, wherein the base includes at least one grip surface configured to inhibit sliding movement of the base on the flat surface.

15. The collapsible garbage container of claim 1, further comprising a hands-free lid opener assembly operably coupled to the lid and configured to selectably place the lid in the open state and the closed state.

16. The collapsible garbage container of claim 15, wherein the hands-free lid opener assembly includes a foot pedal and an activator, the activator joining the lid to the foot pedal such that when the foot pedal is pressed, the activator acts to lift the lid.

17. A collapsible garbage container configured to be cleaned, the collapsible garbage container having a top, a bottom, a deployed configuration, and a decoupled configuration, the collapsible garbage container comprising:
a garbage opening configured to receive a garbage, the garbage opening including a garbage bag retainer,
a base configured to support the collapsible garbage container on a flat surface, and further configured to prevent the garbage from exiting the bottom of the collapsible garbage container when the collapsible garbage container is in the deployed configuration, and wherein the base includes a basin configured to retain at least 3 liters of a liquid;
a collapsible sidewall circumscribing the garbage opening and extending between the garbage opening and the base, the collapsible sidewall configured to retain the garbage from laterally exiting the collapsible garbage container when the collapsible garbage container is in the deployed configuration, the collapsible sidewall removably coupled to the base, the collapsible sidewall including a plurality of sidewall segments removably coupled together;
a lid removably coupled to the collapsible sidewall, said lid having an open state and a closed state, the lid configured to permit the garbage to enter the garbage opening while in the open state, and further configured to prevent the garbage from entering the garbage opening while in the closed state;
wherein each of the plurality of sidewall segments includes at least one male insert and at least one female receiver on opposing ends that are configured such that the plurality of sidewall segments coupleable together;
wherein each of the plurality of plurality of sidewall segments includes at least one male insert and at least one female receiver on opposing ends that are configured such that the plurality of mid-sectional pieces is decoupleable; and
wherein the collapsible garbage container, when in the decoupled configuration, is structured and arranged to be automatically cleaned by a dishwasher and alternatively manually cleaned by hand.

18. The collapsible garbage container configured to be cleaned of claim 17 further comprising at least one handle affixed to the collapsible sidewall.

19. The collapsible garbage container configured to be cleaned of claim 17 further comprising a hands-free lid opener assembly operably coupled to the lid and configured to selectably place the lid in the open state and the closed state.

20. A method of using a collapsible garbage container configured to be cleaned comprising the steps of:
providing the collapsible garbage container;
disposing of at least one piece of garbage inside a garbage bag retained by a garbage bag retainer of a garbage opening of the collapsible garbage container;
removing the garbage bag when full;
collapsing the collapsible garbage container into a decoupled configuration, the decoupled configuration comprising a plurality of parts including the garbage opening, a base, a collapsible sidewall including a plurality of sidewall segments, and a lid;
cleaning the plurality of parts via a dishwasher and alternatively washing the plurality of parts by hand;
assembling the plurality of parts into a deployed configuration; and
deploying the collapsible garbage container for continuous sanitary use thereof.
